(19) United States
(12) Patent Application Publication
(10) Pub. No.: US 2015/0101984 A1
(43) Pub. Date: Apr. 16, 2015

(54) WATER PURIFICATION SYSTEM

(71) Applicant: Global Customized Water, LLC, Camarillo, CA (US)

(72) Inventors: David Beeman, Camarillo, CA (US); Joshua Ingram, Camarillo, CA (US)

(21) Appl. No.: 14/511,236

(22) Filed: Oct. 10, 2014

Related U.S. Application Data
(60) Provisional application No. 61/890,158, filed on Oct. 11, 2013.

(51) Int. Cl. C02F 9/00; C02F 1/00

(52) U.S. Cl. CPC C02F 9/00; C02F 1/008; C02F 1/52
USPC 210/638; 210/195.2; 210/96.2

(57) ABSTRACT

The present specification discloses a water purification system, a water reformulation system, a method of purifying and/or treating water, and a method of reformulating water.

This application claims benefit of U.S. Provisional Application No. 61/890,158, filed on Oct. 11, 2013, incorporated in its entirety by reference herein.

### BACKGROUND OF THE DISCLOSURE

Water purification systems employing a reverse osmosis system is used in both industrial processes as well as in producing potable water. Reverse osmosis is the process of forcing a solvent from a region of high solute concentration through a semipermeable membrane to a region of low solute concentration by applying a pressure in excess of the osmotic pressure. The result is that the water is allowed to pass through the membrane while the solutes are retained on the pressurized side of the membrane. To be selective, the semi-permeable membrane should not allow large solutes through the pores, but should allow smaller components of the solution (such as water molecules) to pass freely. Reverse osmosis can remove a wide spectrum of undesirable solutes normally present in the water, including, without limitation, minerals, ions, impurities and contaminants.

Water purification systems using reverse osmosis utilize a waste water flow control or restrictor to create a back pressure or driving force that increases water pressure in the system. This differential force produces the necessary pressure used by a semi-permeable membrane to separate water molecules from dissolved minerals. However, the pressure generated from this restrictor design is not optimal and is, in part, limited to the starting pressure of the water delivered through municipal lines. Since many municipalities have low water pressure, the increased water pressure achieved in such systems is relatively low in absolute terms. This low pressure reduces the efficiency of a purification system to purify water and results in high volumes of unpurified water. For example, it is estimated that in consumer water purification systems no more than 15% of the flow through is purified water, the rest being unpurified water. Although commercial/municipal water purification systems can achieve 70-90% recovery of flow through, effective contaminant removal rates are reduced. As such, there is a need to develop a reverse osmosis system that can produce high water pressure in absolute terms and in a consistent manner.

One problem associated with reverse osmosis systems is scale build-up. As water permeates the membrane solute concentrations build on the opposite side of the membrane. Over time, this increasing solute concentration results in precipitation of the solutes which will plug up the pores of the membrane (i.e., scaling), thereby preventing permeation of the water. Scale build-up results in a dramatic loss of membrane functionality in a relatively short period of time forcing costly membrane replacements. For example, the typical 2-4 year life-span of a semi-permeable membrane can be reduced to as little as 3-6 months if scale build-up is left unchecked. Thus, this concentrated solute water must be flushed off the membrane in order to prevent scale build-up. As such, there is a need to develop a reverse osmosis system that can prevent and/or eliminate scale build-up on the semi-permeable membrane.

Another problem associated with reverse osmosis systems is the growth of bacteria on the semi-permeable membrane. As discussed above, although the net water pressure achieved by restrictor-based water purification systems is sufficient to purify water across a semi-permeable membrane, the overall water pressure is low. This low water pressure results in slow water flow speed or turbulence. Slow turbulence across the semi-permeable membrane increases the likelihood of bacterial growth on the membrane as the water speed is inadequate to flush the bacteria out of the reverse osmosis apparatus with the unpurified water. Bacteria growth physically clogs up the pores in the semi-permeable membrane which blocks water molecules from crossing the membrane and increases the amount of pressure required to push water though partially blocked pores. These overall negative consequences results in lower water production (lower water purification efficiency) and reduced membrane life-span (higher operating costs). As such, there is a need to develop a reverse osmosis system that can prevent and/or eliminate bacterial growth on the semi-permeable membrane.

Another problem associated with reverse osmosis systems is the disposal of water comprising the concentrated solute generated by this process (i.e., unpurified water). Currently all reverse osmosis systems simply dispose of the unpurified water by running the water stream directly into a municipal sewer line; or store the unpurified water for eventual use in application not requiring potable water, such as, e.g., use in a dishwasher. Some no/low waste reverse osmosis systems use pumps to push the municipal water back into the plumbing lines. However, such systems essentially exchange electrical power and the associated fossil fuel usage to power the pumps creating a complicated and inefficient method of saving water by wasting fuel and energy in its place. Since water is a renewable resource, unlike fossil fuels, it is a far more environmentally sound concept to develop a no waste reverse osmosis system that maintains the existing power consumption, simplicity, and size by developing a system that simply closes the loop on the input municipal water and allows for normal water usage in the establishment.

Another problem associated with reverse osmosis systems is that the process not only removes harmful contaminants that may be present in the water, it can deplete many of the good, healthy minerals from the water due to membrane construction. These beneficial minerals add to the taste of the water as well as the flavor of beverages brewed with water. Normal municipal water has a wide range of mineral content, typically as low as about 10 ppm to as high as about 1700 ppm. Water purified using a reverse osmosis process has a low mineral content, usually in the range of about 5 ppm to 50 ppm total dissolved solids (TDS). The water-purification field has continually advanced that this low TDS range is the hallmark of water purification. However, mineral content greatly influences the flavor of water, especially in brewed beverages, such as, e.g., coffee, tea and beer. Thus, a water purification system using reverse osmosis that can adjust or reformulate the mineral content of purified water would be an advantage since it would provide a means of quality control greatly desired by industries like the coffee, tea and beer brewing industries. As such, there is a need to develop a reverse osmosis system that can reformulate purified water to a desired mineral content.

The present specification discloses a water purification system using reverse osmosis that solves the problems discussed above. Overall the disclosed system provides consistently high water pressure during the reverse osmosis step, reduces scale formation throughout the building plumbing system using media treatment and will as increase turbulence or water flow speed, eliminates water disposal by reusing water not purified by reverse osmosis, eliminates the need of a water softener, does not increase the use of other energy resources in the processing of purified water and has the optional ability to adjust the mineral content of the finished water for flavor enhancement.

### SUMMARY OF THE DISCLOSURE

Aspect of the present specification disclose a water purification system for the purification and/or treatment of water. A water purification system disclosed herein may comprise a mixing tank, a high pressure pump, a reverse osmosis apparatus. A mixing tank disclosed herein may comprise a reactive media that forms colloid particles with dissolved solids present in the water. A high pressure pump disclosed herein is configured to pump high pressure water to the reverse osmosis apparatus in order to provide consistent and sufficient pressure which ensures effective operation of a reverse osmosis apparatus. A reverse osmosis apparatus disclosed herein produces permeate water and concentrate water and is configured to direct the concentrate water back into the mixing tank. A water purification system disclosed herein may further comprise one or more filtration tanks comprising a filtration media that removes suspended particulate matter and/or removes organic contaminants from the water, a holding tank for permeate water, a recirculating pump that circulates permeate water contained in the holding tank, and a delivery pump that pumps permeate water to point-of-use sites of an establishment.

Other aspect of the present specification disclose a water reformulation system. A water reformulation system disclosed herein may comprise a reformulation sensor that collects data on mineral concentration in water, a total dissolved solids module that receives the data, a peristaltic pump, one or more additive tanks, and a recirculating pump. A water purification system disclosed herein may further comprise a water reformulation system disclosed herein. When adjustment of mineral content is required, the total dissolved solids module turns on the peristaltic pump, the peristaltic pump separately draws the additives contained in the one or more additive tanks and releases the additives into the permeate water contained in the holding tank, and the additives are mixed with the permeate water using the water flow created by the recirculating pump.

Yet other aspect of the present specification disclose a method of purifying or treating water using a water purification system disclosed herein and/or a water reformulation system disclosed herein.

### BRIEF DESCRIPTION OF THE DRAWINGS

FIG. 1 illustrates a water purification system disclosed herein.

FIG. 2 illustrates a water purification system disclosed herein comprising a water reformulation system disclosed herein.

### DETAILED DESCRIPTION OF THE DISCLOSURE

One advantage of the disclosed water purification system is the use of a proprietary resin that eliminates scale formation without the addition of any chemicals or mineral exchange. Reducing scale becomes possible both on the membrane surface and at all water service connections served by the mixing tank. The scale reducing media has a 5 year estimated life and requires no water backwashing as compared to conventional water softening that uses salt and backwash water that under certain conditions increases total water use by 10% thereby increasing the overall “green” effect and eliminating the need for salt softening.

A key aspect of the no waste reverse osmosis system is the ability to maintain normal membrane life of 24 to 48 months. The ability to maintain membrane life is critical to the concept of environmentally green. Simply exchanging a shorter membrane life is counter-productive, increases overall system cost and would exchange eliminating water waste for increased energy usage and plastic (membrane) usage along with increased service calls and the burning of fossil fuels to provide that service. A true “green” technology maintains or extends current service intervals uses less and has an overall lower impact. All other techniques that reduce or eliminate water usage simply exchange water use for fossil fuel, plastic, expense and electricity increases.

A water purification system disclosed herein comprises one or more mixing tanks including a reactive media, one or more filtration tanks including a filtration media, a reverse osmosis apparatus, a holding tank for permeate water, a delivery pump, and optionally, one or more adsorption tanks including adsorption media and a recirculating pump. A water purification system disclosed herein may further comprise a water reformulation system. A water reformulation system disclosed herein comprises one or more additive tanks, a peristaltic pump, total dissolved solids module, a reformulation sensor, and a recirculating pump.

In some embodiments, a water purification system disclosed herein is configured to tank municipal water, purify and treat the water, and return the purified and/or treated water to point-of-use sites in an establishment and comprises a mixing tank comprising a reactive media that forms colloid particles with dissolved solids present in the water, a first filtration tank comprising a filtration media that removes suspended particulate matter from the water, a high pressure pump configured to pump high pressure water to a reverse osmosis apparatus capable of producing permeate water and concentrate water, and configured to return at least 95% of the concentrate water back into the mixing tank, a holding tank for permeate water, a water reformulation system contained within the holding tank, a delivery pump contained within the holding tank, and a second filtration tank comprising a filtration media that removes organic contaminants from the water. In aspects of this embodiment, the water reformulation system comprises a reformulation sensor that collects data on mineral concentration in water, a total dissolved solids module that receives the data from the sensor, a first additive tank comprising a first additive, a second additive tank comprising a second additive, a peristaltic pump that separately draws the first additive from the first additive tank and the second additive from the second additive tank and releases the first and second additives into the permeate water contained in the holding tank, and a recirculating pump that circulates the permeate water in order to mix the first and second additives with the permeate water.

In some embodiments, a water purification system disclosed herein is configured to tank municipal water, purify and treat the water, and return the purified and/or treated water to point-of-use sites in an establishment and comprises a mixing tank comprising a reactive media that forms colloid particles with dissolved solids present in the water, a first filtration tank comprising a filtration media that removes suspended particulate matter from the water, a high pressure pump configured to pump high pressure water to a reverse osmosis apparatus capable of producing permeate water and concentrate water, and configured to return at least 95% of the concentrate water back into the mixing tank, a holding tank for permeate water, a delivery pump contained within the holding tank, and a second filtration tank comprising a filtration media that removes organic contaminants from the water.

Municipal water refers to any water that is delivered to an establishment including, without limitation, well water, lake water processed by a municipality like a town or city, or sea water processed by a municipality like a town or city. An establishment is any residential or commercial facility that is sourced with a municipal water supply. In some embodiments, an establishment using a water purification system disclosed herein is a commercial facility. In some embodiments, an establishment using a water purification system disclosed herein is a residential facility. In some embodiments, an establishment using a water purification system disclosed herein is not a residential facility.

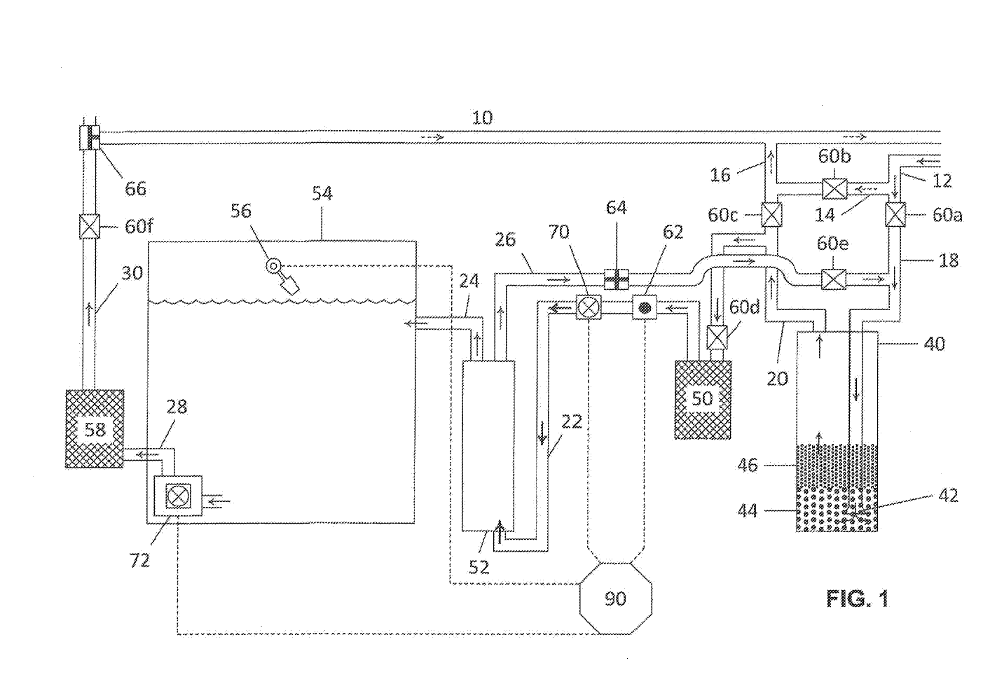

Water purification system disclosed herein may be in a close configuration or an open configuration. In the close configuration municipal water is diverted from entering the water purification system and as such, municipal water remains. Closed configuration of water purification system disclosed herein is useful for allowing inspection, maintenance and/or repair of one or more components of the water purification system disclosed herein. In one embodiment, reference is made to water purification system 10 of FIG. 1. In the closed configuration, ball valve 60a and ball valve 60c are closed and ball valve 60b is open. Municipal water flows from main in-let pipe 12 through bypass pipe 14 and then into main out-let pipe 16. Municipal water then flows through main out-let pipe 16 to the establishment.

Municipal water enters into the water purification system disclosed herein when in the open configuration. Open configuration of water purification system disclosed herein is useful for purifying and treating municipal water. In one embodiment, reference is made to water purification system 10 of FIG. 1. In the open configuration, ball valve 60a and ball valve 60c are open and ball valve 60b is closed. Municipal water flows from main in-let pipe 12 passing ball valve 60a into a water purification system disclosed herein. Water pressure typical of water delivered to an establishment by a municipality is sufficient to enable the flow of water into a water purification system disclosed herein. For example, water pressure sufficient to enable the flow of water into a water purification system disclosed herein may be, e.g., about 20 psi to about 60 psi, about 25 psi to about 60 psi, about 30 psi to about 60 psi, about 35 psi to about 60 psi, about 40 psi to about 60 psi, about 45 psi to about 60 psi, or about 50 psi to about 60 psi.

A water purification system disclosed herein comprises one or more purification and/or treatment steps. In some embodiments, water may be purified and/or treated using a process that reduces one or more dissolved solids present in the water and/or removes particulate material suspended in the water, and/or removes organic contaminants present in the water. Dissolved solids include, without limitation, mineral, metals, and salts present in the water. In aspects of these embodiments, a water purification system disclosed herein comprise two or more, three or more, four or more, five or more, purification and/or treatment steps.

In aspects of these embodiments, a water purification system disclosed herein comprises one or more water purification and/or treatment steps comprising a reactive media. A reactive media catalyzes or facilitates a reaction that removes dissolved solids present in the water, such as, e.g., iron, manganese, chlorine, hydrogen sulfide, carbon dioxide, and calcium carbonate. A reactive media can be a true catalyst that does not get consumed by the chemical reaction or may be a sacrificial catalyst that get used up by the reaction. Reactive media is useful for preventing or reducing build-up of solids on a semi-permeable membrane, thereby eliminating scale formation. Non-limiting examples of reactive media include, BRIM® (Systematrix, USA, Buena Park, Calif.), Calcite (Systematrix, USA, Buena Park, Calif.), COROSEX® (Systematrix, USA, Buena Park, Calif.), Greensand (Systematrix, USA, Buena Park, Calif.), PYROLOX® (Systematrix, USA, Buena Park, Calif.), KDF® (Systematrix, USA, Buena Park, Calif.), SCALESTOP™ (Systematrix, USA, Buena Park, Calif.) and FILTERSORB SP3® (CWG/Watch Water, USA, Largo, Fla.). Although only one water purification and/or treatment step comprising a reactive media may be needed, more than one such step may be required depending on the concentration of dissolved solids present in the municipal water. In aspects of these embodiments, a water purification system disclosed herein comprise two or more, three or more, four or more, five or more, purification and/or treatment steps comprising a reactive media.

In aspects of these embodiments, a reactive media disclose herein is a saltless reactive media. Saltless reactive media comprise one or more resins that prevent precipitation of dissolved solids without the addition of any chemicals or mineral exchange. Non-limiting examples of saltless anti-scale media include FILTERSORB SP3® and SCALESTOP™ which can prevent precipitation of calcium and magnesium precipitation without the addition of any chemicals or mineral exchange.

In other aspects of these embodiments, a water purification system disclosed herein comprises one or more water purification and/or treatment steps comprising a filtration media. A filtration media removes suspended particulate matter like sand, silt, sediment, and/or dirt by trapping or filtering the matter away from the water. A filtration media may be a nanofiltration media, ultrafiltration media and microfiltration media. In aspects of these embodiments, two or more, three or more, four or more, of five or more, filtration media may be used to purify and/or treat water. In aspects of these embodiments, a filtration media may comprise graded layers of gravel and sand. In other aspects of these embodiments, a filtration media may comprise graded layers of gravel, sand and anthracite coal. In yet other aspects of these embodiments, a filtration media may comprise graded layers of gravel, garnet, and sand. In still other aspects of these embodiments, a filtration media may comprise graded layers of gravel, garnet, sand and anthracite coal. Non-limiting examples of filtration media include, anthracite coal (Systematrix, USA, Buena Park, Calif.), FILTER-AG® (Systematrix, USA, Buena Park, Calif.), garnet, gravel, NEXTSAND™ (Systematrix, USA, Buena Park, Calif.), and sand. Although only one water purification and/or treatment step comprising a filtration media may be needed, more than one such step may be required depending on the types and amount of suspended particulate matter present in the municipal water. In aspects of these embodiments, a water purification system disclosed herein comprise two or more, three or more, four or more, five or more, purification and/or treatment steps comprising a filtration media.

In some embodiment, a filtration media can remove suspended solids that are, e.g., at least 5 μm, at least 10 μm, at least 15 μm, at least 20 μm, at least 30 μm, at least 40 μm, at least 50 μm, at least 60 μm, at least 70 μm, at least 80 μm, at least 90 μm, or at least 100 μm, in average diameter. In some embodiment, a filtration media can remove suspended solids that are, e.g., at most 5 μm, at most 10 μm, at most 15 μm, at most 20 μm, at most 30 μm, at most 40 μm, at most 50 μm, at most 60 μm, at most 70 μm, at most 80 μm, at most 90 μm, or at most 100 μm, in average diameter. In some embodiment, a filtration media can remove suspended solids that are in the range of, e.g., about 5 μm to about 10 μm, about 5 μm to about 20 μm, about 5 μm to about 30 μm, about 5 μm to about 40 μm, about 5 μm to about 60 μm, about 5 μm to about 80 μm, about 5 μm to about 100 μm, about 10 μm to about 20 μm, about 10 μm to about 30 μm, about 10 μm to about 40 μm, about 10 μm to about 60 μm, about 10 μm to about 80 μm, about 10 μm to about 100 μm, about 20 μm to about 40 μm, about 20 μm to about 60 μm, about 20 μm to about 80 μm, about 20 μm to about 100 μm, about 40 μm to about 60 μm, about 40 μm to about 80 μm, about 40 μm to about 100 μm, about 60 μm to about 80 μm, about 60 μm to about 100 μm, or about 80 μm to about 100 μm.

In aspects of these embodiments, a water purification system disclosed herein comprises one or more water purification and/or treatment steps comprising an adsorptive media. Adsorptive media adsorbs dissolved solids and organic contaminants like arsenic, chlorine, and fluoride which can cause unpleasant odors, tastes, color, and/or turbidity in the water. Non-limiting examples of adsorptive media include, activated carbon (Systematrix, USA, Buena Park, Calif.), activated alumina (Systematrix, USA, Buena Park, Calif.), ARSENXNP™ (Systematrix, USA, Buena Park, Calif.), and BONE CHAR™ (Systematrix, USA, Buena Park, Calif.). Although only one water purification and/or treatment step comprising an adsorptive media may be needed, more than one such step may be required depending on the concentration of dissolved solids and organic contaminants present in the municipal water. In aspects of these embodiments, a water purification system disclosed herein comprise two or more, three or more, four or more, five or more, purification and/or treatment steps comprising an adsorptive media.

In one embodiment, reference is made to water purification system 10 of FIG. 1. Municipal water flows from main in-let pipe 12 passing ball valve 60a into mixing tank 40 via mixing tank in-let pipe 18. Mixing tank in-let pipe 18 delivers water toward bottom mixing tank 40 through distributor 42. Distributor 42 disperses the water through filter media layer 44 in order to achieve an even and equal flow distribution of water in addition to removal of suspended solids. Such water distribution ensures sufficient interaction of the dissolved solids in the water with reactive media 48 as the water flows upward from filter media layer 44 into reactive media layer 46. In an aspect of this embodiment, the reactive media is a saltless reactive media that forms colloid particles, thereby disabling scale from forming at a later point in the reverse osmosis processing.

Reactive media-treated water may then be handled in one of two ways. If no further purification or processing is required, media-treated water may be delivered directly to point-of-use sites of the establishment. This may be accomplished by opening ball valve 60c and closing ball valve 60b, one-way check valve 60d and three-way ball valve 66.

If addition purification and/or treatment is required, reactive media-treated water may undergo one or more purification and/or treatment steps using a reactive media disclosed herein and/or a filter media disclosed herein and/or an adsorptive media disclosed herein. In one embodiment, reference is made to water purification system 10 of FIG. 1. Reactive media-treated water is diverted from mixing tank 40 into filter tank 50 via filter tank in-let pipe 20. This can be accomplished by opening one-way check valve 60d and closing ball valve 60c. Filter tank 50 comprises filtration media which removes material contained in reactive media-treated water that can be harmful to a semi-permeable membrane such as, e.g., suspended particulate matter and/or chlorine.

In some embodiments, a water purification system disclosed herein comprises a reverse osmosis process apparatus for the purification and/or treatment of water. A reverse osmosis apparatus disclosed herein typically comprises an intake port, a permeate water port, a concentrate water port, one or more semi-permeable membranes. The membranes may be hollow fiber or spiral wound. Examples of suitable materials used to produce the membranes include cellulose tri-acetate (CTA), cellulose acetate (CA), polyamide and thin film composite (TFC). The membranes can also be considered standard pressure (high pressure) or low energy (low pressure). Examples of commercially available reverse osmosis membranes include spiral-wound TFC membranes (Filmtec, Midland Mich.), such as, e.g., XLE-4021 (low energy) and TW30-4021 (high energy) and MT1812P24 (Applied Membranes, Inc, Vista, Calif.).

Reverse osmosis is an effective mechanism for removing many types of molecules and ions from water. In this process the total dissolved solids (TDS) present in the in-coming water remain with the concentrate water. In operation, an applied pressure is used to overcome osmotic pressure that is driven by chemical potential which results in the passage of pure solvent (e.g., water) through the membrane and the retention of solute (e.g., dissolved solids and colloid particles) on the pressurized side of the membrane. Permeate water refers to the purified water that passes through the semi-permeable membrane while concentrate water refers to the water on the pressurized side of the membrane containing the retained solutes. In some embodiments, the pressure of permeate water leaving reverse osmosis apparatus is atmospheric pressure. In some embodiments, permeate water leaving reverse osmosis apparatus is under pressure.

Permeate water typically has a substantially lower level of total dissolved solids (TDS) then either the incoming filtered water or the concentrate water. In aspects of this embodiment, permeate water has a TDS concentration of, e.g., less than 5 ppm, less than 10 ppm, less than 25 ppm, less than 50 ppm, less than 75 ppm, less than 100 ppm, less than 125 ppm, less than 150 ppm, less than 175 ppm, or less than 200 ppm. In other aspects of this embodiment, permeate water has a TDS concentration in the range of, e.g., about 5 ppm to about 50 ppm, about 5 ppm to about 75 ppm, about 5 ppm to about 100 ppm, about 10 ppm to about 50 ppm, about 10 ppm to about 75 ppm, about 10 ppm to about 100 ppm, about 25 ppm to about 50 ppm, about 25 ppm to about 75 ppm, about 25 ppm to about 100 ppm, about 25 ppm to about 125 ppm, about 25 ppm to about 150 ppm, about 25 ppm to about 175 ppm, about 25 ppm to about 200 ppm, about 50 ppm to about 75 ppm, about 50 ppm to about 100 ppm, about 50 ppm to about 125 ppm, about 50 ppm to about 150 ppm, about 50 ppm to about 175 ppm, about 50 ppm to about 200 ppm, about 75 ppm to about 100 ppm, about 75 ppm to about 125 ppm, about 75 ppm to about 150 ppm, about 75 ppm to about 175 ppm, or about 75 ppm to about 200 ppm.

Concentrate water typically has a substantially higher level of TDS then either the incoming filtered water or the permeate water. In aspects of this embodiment, concentrate water has a TDS concentration of, e.g., more than 400 ppm, more than 500 ppm, more than 600 ppm, more than 700 ppm, more than 800 ppm, more than 900 ppm, more than 1,000 ppm, more than 1,250 ppm, more than 1,500 ppm, more than 1,750 ppm, more than 2,000 ppm, more than 2,250 ppm, more than 2,500 ppm, more than 2,750 ppm, or more than 3,000 ppm.

In other aspects of this embodiment, concentrate water has a TDS concentration in the range of, e.g., about 400 ppm to about 600 ppm, about 400 ppm to about 800 ppm, about 400 ppm to about 1,000 ppm, about 400 ppm to about 1,500 ppm, about 400 ppm to about 2,000 ppm, about 400 ppm to about 2,500 ppm, about 400 ppm to about 3,000 ppm, about 500 ppm to about 600 ppm, about 500 ppm to about 800 ppm, about 500 ppm to about 1,000 ppm, about 500 ppm to about 1,500 ppm, about 500 ppm to about 2,000 ppm, about 500 ppm to about 2,500 ppm, about 500 ppm to about 3,000 ppm, about 600 ppm to about 800 ppm, about 600 ppm to about 1,000 ppm, about 600 ppm to about 1,500 ppm, about 600 ppm to about 2,000 ppm, about 600 ppm to about 2,500 ppm, about 600 ppm to about 3,000 ppm, about 700 ppm to about 800 ppm, about 700 ppm to about 1,000 ppm, about 700 ppm to about 1,500 ppm, about 700 ppm to about 2,000 ppm, about 700 ppm to about 2,500 ppm, about 700 ppm to about 3,000 ppm, about 800 ppm to about 1,000 ppm, about 800 ppm to about 1,500 ppm, about 800 ppm to about 2,000 ppm, about 800 ppm to about 2,500 ppm, about 800 ppm to about 3,000 ppm, about 1,000 ppm to about 1,250 ppm, about 1,000 ppm to about 1,500 ppm, about 1,000 ppm to about 2,000 ppm, about 1,000 ppm to about 2,500 ppm, about 1,000 ppm to about 3,000 ppm, about 1,500 ppm to about 2,000 ppm, about 1,500 ppm to about 2,500 ppm, about 1,500 ppm to about 3,000 ppm, about 2,000 ppm to about 2,500 ppm, or about 2,000 ppm to about 3,000 ppm.

In other embodiments, permeate water has a lower TDS concentration relative to concentrate water by, e.g., at least 200 ppm, at least 300 ppm, at least 400 ppm, at least 500 ppm, at least 600 ppm, at least 700 ppm, at least 800 ppm, at least 900 ppm, at least 1,000 ppm, at least 1,250 ppm, at least 1,500 ppm, at least 1,750 ppm, at least 2,000 ppm, at least 2,250 ppm, at least 2,500 ppm, at least 2,750 ppm, or at least 3,000 ppm. In other aspects, permeate water has a lower TDS concentration relative to concentrate water in the range of, e.g., about 400 ppm to about 600 ppm, about 400 ppm to about 800 ppm, about 400 ppm to about 1,000 ppm, about 400 ppm to about 1,500 ppm, about 400 ppm to about 2,000 ppm, about 400 ppm to about 2,500 ppm, about 400 ppm to about 3,000 ppm, about 500 ppm to about 600 ppm, about 500 ppm to about 800 ppm, about 500 ppm to about 1,000 ppm, about 500 ppm to about 1,500 ppm, about 500 ppm to about 2,000 ppm, about 500 ppm to about 2,500 ppm, about 500 ppm to about 3,000 ppm, about 600 ppm to about 800 ppm, about 600 ppm to about 1,000 ppm, about 600 ppm to about 1,500 ppm, about 600 ppm to about 2,000 ppm, about 600 ppm to about 2,500 ppm, about 600 ppm to about 3,000 ppm, about 700 ppm to about 800 ppm, about 700 ppm to about 1,000 ppm, about 700 ppm to about 1,500 ppm, about 700 ppm to about 2,000 ppm, about 700 ppm to about 2,500 ppm, about 700 ppm to about 3,000 ppm, about 800 ppm to about 1,000 ppm, about 800 ppm to about 1,500 ppm, about 800 ppm to about 2,000 ppm, about 800 ppm to about 2,500 ppm, about 800 ppm to about 3,000 ppm, about 1,000 ppm to about 1,250 ppm, about 1,000 ppm to about 1,500 ppm, about 1,000 ppm to about 2,000 ppm, about 1,000 ppm to about 2,500 ppm, about 1,000 ppm to about 3,000 ppm, about 1,500 ppm to about 2,000 ppm, about 1,500 ppm to about 2,500 ppm, about 1,500 ppm to about 3,000 ppm, about 2,000 ppm to about 2,500 ppm, or about 2,000 ppm to about 3,000 ppm.

In some embodiments, a water purification system disclosed herein is configured to return concentrate water back through one or more water purification and/or treatment steps disclosed herein, including those comprising reactive media, filtration media and adsorption media. This design avoids the need to dispose of any concentrate water into a municipal sewer line, avoids the need to store concentrate water for eventual use in application not requiring potable water; and avoids the need to use high-energy electrical pump to push the concentrate water back into the plumbing lines. As such, a water purification system disclosed herein does not dispose of or store concentrate water, but instead returns the concentrate water back though one or more water purification and/or treatment steps disclosed herein.

In some embodiment, substantially all the concentrate water is returns the concentrate water back though one or more water purification and/or treatment steps disclosed herein. In an aspect of this embodiment, the amount of concentrate water returned back though one or more water purification and/or treatment steps disclosed herein may be 100%. In aspects of this embodiment, the amount of concentrate water returned back though one or more water purification and/or treatment steps disclosed herein may be, e.g., at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%. In other aspects of this embodiment, the amount of concentrate water returned back though one or more water purification and/or treatment steps disclosed herein is in the range of, e.g., about 70% to about 100%, about 75% to about 100%, about 80% to about 100%, about 85% to about 100%, about 86% to about 100%, about 87% to about 100%, about 88% to about 100%, about 89% to about 100%, about 90% to about 100%, about 91% to about 100%, about 92% to about 100%, about 93% to about 100%, about 94% to about 100%, about 95% to about 100%, about 96% to about 100%, about 97% to about 100%, about 98% to about 100%.

In some embodiments, a water purification system disclosed herein has a minimal water to waste ratio is 1:0. This means that for every gallon of permeate water produced, no concentrate (or unpurified) water is disposed into a municipal sewer line, stored for a subsequent use, or otherwise not returned to the water purification system for addition processing. In other aspects of this embodiment, a water purification system disclosed herein has a minimal water to waste ratio of, e.g., no more than 1:0.1, no more than 1:0.2, no more than 1:0.3, no more than 1:0.4, no more than 1:0.5, no more than 1:0.6, no more than 1:0.7, no more than 1:0.8, or no more than 1:0.9. In other aspects of this embodiment, a water purification system disclosed herein has a minimal water to waste ratio in the range of, e.g., about 1:0 to about 1:0.1, about 1:0 to about 1:0.2, about 1:0 to about 1:0.3, about 1:0 to about 1:0.4, about 1:0 to about 1:0.5, about 1:0 to about 1:0.6, about 1:0 to about 1:0.7, about 1:0 to about 1:0.8, about 1:0 to about 1:0.9, about 1:0.1 to about 1:0.2, about 1:0.1 to about 1:0.3, about 1:0.1 to about 1:0.4, about 1:0.1 to about 1:0.5, about 1:0.1 to about 1:0.6, about 1:0.1 to about 1:0.7, about 1:0.1 to about 1:0.8, about 1:0.1 to about 1:0.9, about 1:0.2 to about 1:0.3, about 1:0.2 to about 1:0.4, about 1:0.2 to about 1:0.5, about 1:0.2 to about 1:0.6, about 1:0.2 to about 1:0.7, about 1:0.2 to about 1:0.8, or about 1:0.2 to about 1:0.9.

In some embodiments, a water purification system disclosed herein comprises a holding tank for permeate water. In an aspect of this embodiment, the pressure of permeate water stored in holding tank is atmospheric pressure. In another aspect of this embodiment, the permeate water stored in holding tank is under pressure.

In some embodiment, a water purification system disclosed herein comprises a storage tank for concentrate water. In some embodiment, a water purification system disclosed herein does not comprise a storage tank for concentrate water.

In some embodiments, a water purification system disclosed herein comprises a high pressure pump. Use of high-pressure pump disclosed herein enables production high-pressured water at a constant pressure, irrespective of the starting pressure of the water delivered by the municipality. The net effect is that the high pressure pump boosts the water pressure in a manner that overcomes the municipal water back pressure and becomes the driving force that pushes the water against the semi-permeable membrane of a reverse osmosis apparatus. The increased water pressure created by a high-pressure pump disclosed herein increases the efficiency of separating water molecules across the semi-permeable membrane. In addition, the increased turbulence created by high-pressure pump increases water flow against the semi-permeable membrane, thereby reducing scale build-up as well as bacterial growth on the membrane. Furthermore, increased water pressure created by a high-pressure pump disclosed herein enables the return of concentrate water back through one or more water purification and/or treatment steps disclosed herein, including those comprising reactive media, filtration media and adsorption media.

In aspects of this embodiment, a water purification system disclosed herein comprises a high-pressure pump that increases the water pressure by, e.g., at least 10 psi, at least 15 psi, at least 20 psi, at least 25 psi, at least 30 psi, at least 35 psi, at least 40 psi, at least 45 psi, at least 50 psi, at least 55 psi, at least 60 psi, at least 65 psi, at least 70 psi, or at least 75 psi. In other aspects of this embodiment, a water purification system disclosed herein comprises a high-pressure pump that increases the water pressure in a range of, e.g., at most 10 psi, at most 15 psi, at most 20 psi, at most 25 psi, at most 30 psi, at most 35 psi, at most 40 psi, at most 45 psi, at most 50 psi, at most 55 psi, at most 60 psi, at most 65 psi, at most 70 psi, or at most 75 psi. In yet other aspects of this embodiment, a water purification system disclosed herein comprises a high-pressure pump that increases the water pressure in a range of, e.g., about 10 psi to about 60 psi, about 15 psi to about 60 psi, about 20 psi to about 60 psi, about 25 psi to about 60 psi, about 30 psi to about 60 psi, about 35 psi to about 60 psi, about 40 psi to about 60 psi, about 45 psi to about 60 psi, about 50 psi to about 60 psi, about 10 psi to about 65 psi, about 15 psi to about 65 psi, about 20 psi to about 65 psi, about 25 psi to about 65 psi, about 30 psi to about 65 psi, about 35 psi to about 65 psi, about 40 psi to about 65 psi, about 45 psi to about 65 psi, about 50 psi to about 65 psi, about 10 psi to about 70 psi, about 15 psi to about 70 psi, about 20 psi to about 70 psi, about 25 psi to about 70 psi, about 30 psi to about 70 psi, about 35 psi to about 70 psi, about 40 psi to about 70 psi, about 45 psi to about 70 psi, about 50 psi to about 70 psi, about 10 psi to about 75 psi, about 15 psi to about 75 psi, about 20 psi to about 75 psi, about 25 psi to about 75 psi, about 30 psi to about 75 psi, about 35 psi to about 75 psi, about 40 psi to about 75 psi, about 45 psi to about 75 psi, or about 50 psi to about 75 psi.

In other aspects of this embodiment, water leaving a high pressure pump disclosed herein has a higher pressure relative to water entering the high pressure pump by, e.g., at least 10 psi, at least 15 psi, at least 20 psi, at least 25 psi, at least 30 psi, at least 35 psi, at least 40 psi, at least 45 psi, at least 50 psi, at least 55 psi, at least 60 psi, at least 65 psi, at least 70 psi, or at least 75 psi. In yet other aspects of this embodiment, water leaving a high pressure pump disclosed herein has a higher pressure relative to water entering the high pressure pump in a range of, e.g., about 10 psi to about 20 psi, about 10 psi to about 25 psi, about 10 psi to about 30 psi, about 10 psi to about 35 psi, about 10 psi to about 40 psi, about 10 psi to about 45 psi, about 10 psi to about 50 psi, about 15 psi to about 20 psi, about 15 psi to about 25 psi, about 15 psi to about 30 psi, about 15 psi to about 35 psi, about 15 psi to about 40 psi, about 15 psi to about 45 psi, about 15 psi to about 50 psi, about 20 psi to about 25 psi, about 20 psi to about 30 psi, about 20 psi to about 35 psi, about 20 psi to about 40 psi, about 20 psi to about 45 psi, about 20 psi to about 50 psi, about 30 psi to about 35 psi, about 30 psi to about 40 psi, about 30 psi to about 45 psi, about 30 psi to about 50 psi, about 30 psi to about 55 psi, about 30 psi to about 60 psi, about 40 psi to about 45 psi, about 40 psi to about 50 psi, about 40 psi to about 55 psi, about 40 psi to about 60 psi, about 40 psi to about 65 psi, about 40 psi to about 70 psi, about 45 psi to about 50 psi, about 45 psi to about 55 psi, about 45 psi to about 60 psi, about 45 psi to about 65 psi, or about 45 psi to about 70 psi.

In some embodiment, a water purification system disclosed herein further comprises flow restrictors in order to increase water pressure. A non-limiting example of a flow restrictor is described in U.S. Pat. No. 7,285,210, which is hereby incorporated by reference in its entirety. In some embodiment, a water purification system disclosed herein does not comprise flow restrictors in order to increase water pressure.

In some embodiments, a water purification system disclosed herein comprises solenoid valve. A solenoid valve disclosed herein regulates the volume of water flowing into reverse osmosis apparatus. When insufficient volume of water is present, the solenoid valve is open and water flows into reverse osmosis apparatus. When excessive volume of water is present, the solenoid valve is closed and water is prevented from flowing into reverse osmosis apparatus. Operation of a solenoid valve can be accomplished using a pressure switch or a float device.

In one embodiment, reference is made to water purification system 10 of FIG. 1. Filtered water flows through reverse osmosis in-let pipe 22. Reverse osmosis in-let pipe 22 has one-way check valve 60d which prevents filtered water from reentering filter tank 50 as well as solenoid valve 62. Reverse osmosis in-let pipe 22 also has high-pressure pump 70. High-pressure water then enters into reverse osmosis apparatus 52 via reverse osmosis in-let pipe 22. Concentrate water leaves reverse osmosis apparatus 52 via reverse osmosis out-let pipe 26 where it flows back into mixing tank in-let pipe 18, thereby enabling the reuse of concentrate water through water purification system 10. Out-let pipe 26 has metering value 64 and ball valve 60e. Metering value 64 restricts the flow of concentrate water back to mixing tank 40 which increases the pressure on the semi-membrane of reverse osmosis apparatus 52, thereby resulting in higher production of permeate water. Metering value 64 may be adjusted on order to allow adjustments in water pressure created by high pressure pump 70.

Permeate water leaves reverse osmosis apparatus 52 and flows into holding tank 54 via holding tank in-let pipe 24. Permeate water entering holding tank 54 is stored until needed, now referred to as purified water. The level of stored purified water is monitored via shut-off sensor 56. A shut-off sensor may be a pressure sensor or a float sensor. When water levels are below maximum storage capacity of holding tank 54, water purification system 10 is operating. However, when maximum storage capacity of holding tank 54 is reached, shut-off sensor 56 turns off water purification system 10. Water purification system 10 remains off until shut-off sensor 56 detects water levels below maximum storage capacity of holding tank 54, where upon shut-off sensor 56 signals that water purification system 10 should be turned on again.

Upon demand for purified water, a pressure switch turns on delivery pump 72, which pumps stored purified water into filter tank 58 via holding tank out-let pipe 28. Delivery pump 72 increases pressure of stored purified water to about 45 psi to about 60 psi. Filter tank 58 comprises an activated charcoal filter that removes unwanted taste and/or odors from stored purified water. Filtered water then flows through main out-let pipe 30 (which comprises one-way check valve 60f) to point-of-use sites of establishment requiring purified water. Three-way by-pass valve 66 may be included. This valve enables the flow of purified water to be redirected into out-let pipe 16 and allows for system service or emergency usage in case of equipment shut down and redirects city water to out-let pipe 16.

Power supply 90 provides electrical power to shut-off sensor 56, solenoid valve 62, high pressure pump 70, and delivery pump 72 via wire harnesses. Power supply 90 may include a transformer, such as, e.g., a 110 VAC to 24 VAC rated transformer.

A water purification system disclosed herein may further comprise water reformulation system which provides a mechanism to reformulate purified water by adding additives, such as, e.g., naturally occurring minerals, food-grade and self-certified compounds, and generally regarded as safe (GRAS) compounds. Water processed by reverse osmosis not only removes harmful contaminants but also depletes many of the good, healthy minerals originally present in the water. These beneficial minerals add to the taste of the water as well as the flavor of beverages brewed with water. Reformulation of the water with additives using a reformulation system disclosed herein adds back beneficial minerals in a controlled manner that ensures better quality control of the mineral content water being used at an establishment. In addition, reformulation of water to various TDS levels may be used to simulate water from other areas to demonstrate flavor variability caused by minerals. Non-limiting examples of beneficial minerals include potassium bicarbonate, sodium bicarbonate, and calcium chloride.

A water reformulation system disclosed herein comprises one or more additive tanks that contain the appropriate additives, a peristaltic pump, total dissolved solids module, a reformulation sensor, and a recirculating pump. A reformulation sensor disclosed herein measures the mineral content of the purified water and relays this data to a total dissolved solids module disclosed herein. A total dissolved solids module disclosed herein evaluates the data in order to determine whether the purified water requires reformulation and if so, controls the release of additives to a predetermined level based on the concentration of minerals desired via a peristaltic pump disclosed herein. A peristaltic pump disclosed herein is used to pump additives contained in the additive tanks into the purified water contained in the holding tank. Additives may also be added using a water piston driven pump such as a dosatron style water driven pump. A recirculating pump disclosed herein is used to move the purified water in a controlled manner in order to facilitate proper mixing of additives added to the water.

The one or more additive tanks disclosed herein contain the additives that will be used to reformulate the purified water. Depending on the application, certain additives cannot be premixed since such premixing results in precipitation of the combined additives within the additive tanks and/or other component of a reformulation system disclosed herein. In such cases, two or more additive tanks are required and the reformulation system disclosed herein is designed to separately deliver the additives directly to the purified water in the holding tank. In such a design, the additives are diluted to a sufficient amount to prevent precipitation of the additives. In aspects of this embodiment, a reformulation system disclosed herein comprises, e.g., at least two additive tanks, at least three additive tanks, at least four additive tanks, or at least five additive tanks, each designed to separately deliver the additives directly to the purified water in a holding tank. In other aspects of this embodiment, a reformulation system disclosed herein comprises, e.g., two additive tanks, three additive tanks, four additive tanks, or five additive tanks, each designed to separately deliver the additives directly to the purified water in a holding tank. In other aspects of this embodiment, a reformulation system disclosed herein comprises between, e.g., two to three additive tanks, two to four additive tanks, two to five additive tanks, three to four additive tanks, three to five additive tanks, or four to five additive tanks, each designed to separately deliver the additives directly to the purified water in a holding tank.

In some embodiments, a reformulation system disclosed herein adjusts the beneficial mineral to a desired mineral concentration. In aspects of these embodiments, a reformulation system disclosed herein adjusts the beneficial mineral concentration to, e.g., about 50 ppm, about 75 ppm, about 100 ppm, about 125 ppm, about 150 ppm, about 175 ppm, about 200 ppm, about 300 ppm, about 400 ppm, about 500 ppm, about 600 ppm, about 700 ppm, about 800 ppm, about 900 ppm, about 1,000 ppm, about 1,100 ppm, about 1,200 ppm, about 1,300 ppm, about 1,400 ppm, or about 1,500 ppm. In other aspects of these embodiments, a reformulation system disclosed herein adjusts the beneficial mineral concentration in a range of, e.g., about 50 ppm to 150 ppm, about 50 ppm to 200 ppm, about 50 ppm to 300 ppm, about 50 ppm to 400 ppm, about 50 ppm to 500 ppm, about 75 ppm to 150 ppm, about 75 ppm to 200 ppm, about 75 ppm to 300 ppm, about 75 ppm to 400 ppm, about 75 ppm to 500 ppm, about 100 ppm to 150 ppm, about 100 ppm to 200 ppm, about 100 ppm to 300 ppm, about 100 ppm to 400 ppm, about 100 ppm to 500 ppm, about 125 ppm to 150 ppm, about 125 ppm to 200 ppm, about 125 ppm to 300 ppm, about 125 ppm to 400 ppm, or about 125 ppm to 500 ppm. In yet other aspects of these embodiments, a reformulation system disclosed herein adjusts the beneficial mineral concentration in a range of, e.g., about 100 ppm to 500 ppm, about 100 ppm to 750 ppm, about 100 ppm to 1,000 ppm, about 100 ppm to 1,250 ppm, about 100 ppm to 1,500 ppm, about 100 ppm to 1,750 ppm, about 100 ppm to 2,000 ppm, about 200 ppm to 500 ppm, about 200 ppm to 750 ppm, about 200 ppm to 1,000 ppm, about 200 ppm to 1,250 ppm, about 200 ppm to 1,500 ppm, about 200 ppm to 1,750 ppm, about 200 ppm to 2,000 ppm, about 250 ppm to 500 ppm, about 250 ppm to 750 ppm, about 250 ppm to 1,000 ppm, about 250 ppm to 1,250 ppm, about 250 ppm to 1,500 ppm, about 250 ppm to 1,750 ppm, about 250 ppm to 2,000 ppm, about 500 ppm to 750 ppm, about 500 ppm to 1,000 ppm, about 500 ppm to 1,250 ppm, about 500 ppm to 1,500 ppm, about 500 ppm to 1,750 ppm, or about 500 ppm to 2,000 ppm.

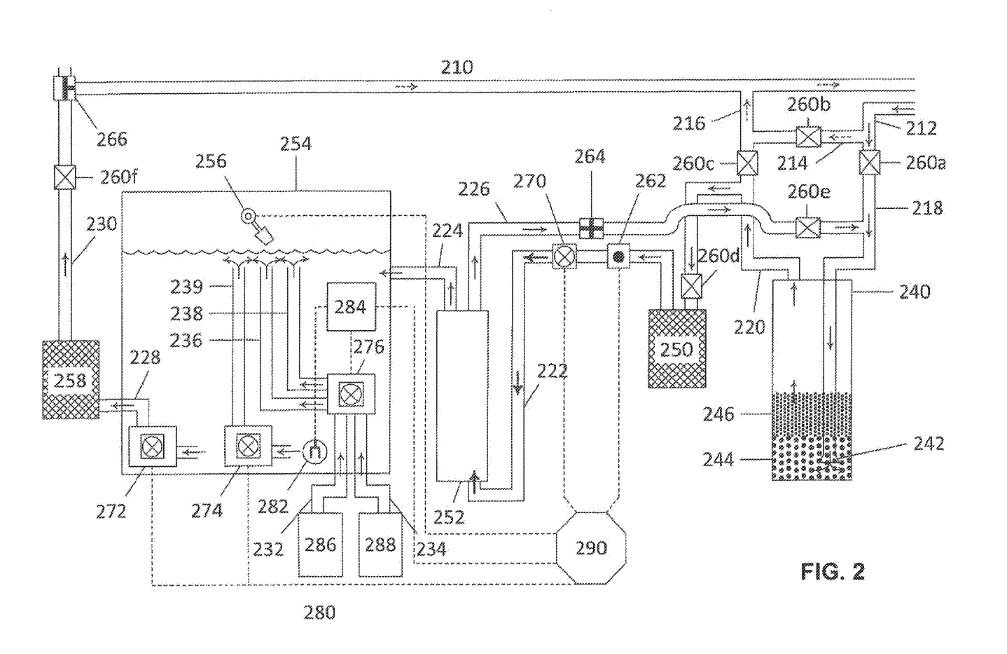

In one embodiment, reference is made to water purification system 210 of FIG. 2. In this system, water reformulation system 280 comprises reformulation sensor 282, total dissolved solids module 284, additive tank A 286, and additive tank B 288. In some embodiments, water reformulation system 280 further comprises recirculating pump 274. In operation, reformulation sensor 282 collects mineral content data of stored purified water contained in holding tank 254. This data is sent to total dissolved solids module 284 which evaluates mineral content data in order to determine whether the stored purified water requires reformulation. If adjustment of mineral content is required, total dissolved solids module 284 turns on peristaltic pump 276. Peristaltic pump 276 separately draws additives contained in additive tank A 286 and additives contained in additive tank B 288 via mixing pump in-let pipe 232 and 234 into holding tank 254 via peristaltic pump out-let pipe 236 and 238. The minerals from additive tank A 286 and additive tank B 288 are then mixed by employing the water flow from recirculating out-let pipe 239 created by recirculating pump 274.

Upon demand for reformulated water, a pressure switch turns on delivery pump 272, which pumps stored reformulated water into filter tank 258 via holding tank out-let pipe 228. Delivery pump 272 increases pressure of stored purified water to about 45 psi to about 60 psi. Filter tank 258 comprises an activated-charcoal filter that removes unwanted taste and/or odors from stored purified water. Filtered water then flows through main out-let pipe 230 (which comprises one-way check valve 260f) to point-of-use sites of establishment requiring purified and/or reformulated water. Three-way by-pass valve 266 may be included. This valve redirects water flow to out-let pipe 216 from purified water to filtered municipal water allowing for equipment service or emergency by-pass in case of equipment breakdown

Power supply 290 provides power to shut-off sensor 256, solenoid valve 262, high pressure pump 270, delivery pump 272, recirculating pump 274, total dissolved solids module 284, mixing pump 276 and reformulation sensor 282. Power supply 290 may include a transformer, such as, e.g., a 110 VAC to 24 VAC rated transformer.

The embodiments described in FIG. 1 and FIG. 2 are provided for illustrative purposes only in order to facilitate a more complete understanding of the water purification system disclosed herein. These embodiments should not be construed to limit any of the other embodiments described in the present specification. Those skilled in the art to which this invention pertains will readily appreciate that numerous changes, variations, and modification can be made to the embodiments depicted in FIG. 1 and FIG. 2, based on the full disclosure of the present specification.

The present specification discloses a method of purifying and/or treating water. In some embodiments, a method of purifying and/or treating water disclosed herein using a water purification system disclosed herein. Typically, a water source like municipal water, is diverted to the water purification system disclosed herein before reaching point-of-use sites. In some embodiments, a water source is diverted to a mixing tank comprising a reactive media that forms colloid particles with dissolved solids present in the water. The reactive media-processed water is then directed to a first filtration tank comprising a filtration media that removes suspended particulate matter from the water. The filtration media-processed water is then directed to a high pressure pump that increases the pressure of the water. The high-pressure water is then diverted to a reverse osmosis apparatus that produces permeate water and concentrate water and is configured to return at substantially all the concentrate water back though one or more water purification and/or treatment steps disclosed herein. The permeate water is diverted to a holding tank for storage, resulting in purified and/or treated water. The purified and/or treated water may subsequently be reformulated using a method of reformulating water. In some embodiments, the purified and/or treated water may subsequently be reformulated using a method of reformulating water disclosed herein.

In an aspect of this embodiment, the amount of concentrate water returned back though one or more water purification and/or treatment steps disclosed herein may be 100%. In aspects of this embodiment, the amount of concentrate water returned back though one or more water purification and/or treatment steps disclosed herein may be, e.g., at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%. In other aspects of this embodiment, the amount of concentrate water returned back though one or more water purification and/or treatment steps disclosed herein is in the range of, e.g., about 70% to about 100%, about 75% to about 100%, about 80% to about 100%, about 85% to about 100%, about 86% to about 100%, about 87% to about 100%, about 88% to about 100%, about 89% to about 100%, about 90% to about 100%, about 91% to about 100%, about 92% to about 100%, about 93% to about 100%, about 94% to about 100%, about 95% to about 100%, about 96% to about 100%, about 97% to about 100%, about 98% to about 100%.

The present specification discloses a method of reformulating water. In some embodiments, a reformulation sensor detects the total dissolved solids of a water source and sends this data to a total dissolved solids module. The total dissolved solids module evaluates the data in order to determine whether adjustment or reformulation of the water source is required. Evaluation may be based on a pre-determined criteria based on industry standards or set by a user employing the reformulation method, such as, e.g., concentration of total dissolved solids, concentration of total minerals, concentration of specific dissolved solids, or concentration of specific minerals. If the evaluation determines that reformulation is necessary, the total dissolved solids module sends a signal that turns on a peristaltic pump. The peristaltic pump is configured to separately draw up additives contained in one or more additive tanks and release the additives into the water source. The released additives are then mixed with the water source using, e.g., a recirculating pump. Once the total dissolved solids module detects that the predetermined criteria for the water source has been achieved, the module turns off the peristaltic pump, thereby stopping the release of the additives.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A water purification system for the purification and/or treatment of water, the system comprising:
a mixing tank comprising a reactive media that forms colloid particles with dissolved solids present in the water;
a high pressure pump that increases the pressure of the water by at least 30 psi;
a reverse osmosis apparatus, the reverse osmosis apparatus producing permeate water and concentrate water;
wherein the high pressure pump is configured to pump high pressure water to the reverse osmosis apparatus; and
wherein the reverse osmosis apparatus is configured to direct at least 85% of the concentrate water back into the mixing tank.

2. The water purification system according to claim 1, wherein the reverse osmosis apparatus is configured to direct 100% of the concentrate water back into the mixing tank.

3. The water purification system according to claim 1, further comprising a first filtration tank comprising a filtration media that removes suspended particulate matter from the water.

4. The water purification system according to claim 1, further comprising a second filtration tank comprising a filtration media that removes organic contaminants from the water.

5. The water purification system according to claim 1, further comprising a delivery pump that pumps permeate water to point-of-use sites of an establishment; and

6. The water purification system according to claim 1, further comprising a holding tank for permeate water.

7. The water purification system according to claim 1, further comprising a recirculating pump used to circulate permeate water contained in the holding tank.

8. The water purification system according to claim 1, wherein the water purification system does not comprise a flow restrictor.

9. The water purification system according to claim 1, wherein the water purification system does not comprise a storage tank for concentrate water.

10. The water purification system according to claim 1, further comprising a water reformulation system, the water reformulation system comprising:
a reformulation sensor that collects data on mineral concentration in water;
a total dissolved solids module that receives the data;
a peristaltic pump;
two or more additive tanks, wherein the two or more additive tanks comprise a first additive tank comprising a first additive and a second additive tank comprising a second additive; and
a recirculating pump;
wherein if adjustment of mineral content is required,
the total dissolved solids module turns on the peristaltic pump;
the peristaltic pump separately draws the first additive from the first additive tank and the second additive from the second additive tank
the first and second additives are released into the permeate water contained in the holding tank; and
the first and second additives are mixed with the permeate water using the water flow created by the recirculating pump.

11. A method of purifying and/or treating water, the method comprising the steps of:
diverting a water source to a mixing tank comprising a reactive media that forms colloid particles with dissolved solids present in the water;
directing reactive media-processed water to a first filtration tank comprising a filtration media that removes suspended particulate matter from the water;
directing filtration media-processed water to a high pressure pump that increases the pressure of the water by at least 30 psi;
directing high pressure water to a reverse osmosis apparatus that produces permeate water and concentrate water; wherein at least 85% of the concentrate water is returned back to the mixing tank.

12. The method according to claim 11, wherein 100% of the concentrate water is returned back to the mixing tank.

13. The method according to claim 11, further comprising the step of directing permeate water into a holding tank.

14. The method according to claim 13, further comprising the step of directing permeate water contained in the holding tank to a second filtration tank comprising a filtration media that removes organic contaminants from the water.

15. The method according to claim 11, wherein the method does not use a flow restrictor to increase water pressure.

16. The method according to claim 11, wherein the method does not store concentrate water for a subsequent use.

17. The method according to claim 13, wherein the method further comprises a method of reformulating water.

18. The method according to claim 17, wherein the method of reformulating water comprises the steps of:
sensing the mineral concentration present in the permeate water;
turning on a peristaltic pump that separately draws additives from one or more additive tanks and releases the additives into the permeate water; and
mixing the additives with the permeate water, thereby resulting in a reformulated water.

19. The method according to claim 18, further comprising the step of directing the reformulated water contained in the holding tank to a second filtration tank comprising a filtration media that removes organic contaminants from the water.
